(19) United States
(12) Patent Application Publication
(10) Pub. No.: US 2025/0019021 A1
(43) Pub. Date: Jan. 16, 2025

(54) MODULAR ROLLING CHASSIS ASSEMBLY FOR SKATEBOARD CHASSIS ARCHITECTURES

(71) Applicant: MAGNA INTERNATIONAL INC., Aurora, Ontario (CA)

(72) Inventors: Mehmed BECIRBASIC, Behamberg (AT); Christoph HÖFER, Hargelsberg (AT); Gabor OESZ, Haag (AT); Martin WINTER, Dietach (AT)

(21) Appl. No.: 18/711,950

(22) PCT Filed: Nov. 9, 2022
(86) PCT No.: PCT/CA2022/051653

§ 371 Date: May 21, 2024

Related U.S. Application Data
(60) Provisional application No. 63/281,957, filed on Nov. 22, 2021.

(51) Int. Cl. B62D 63/02; B60K 1/04; B62D 21/10

(52) U.S. Cl. CPC B62D 63/025; B60K 1/04; B62D 21/10; B60K 2001/0438

(57) ABSTRACT

A modular rolling chassis assembly for an electric vehicle includes a central housing extending from a front end to a rear end to define a central cavity. An electric energy storage system (ESS) is disposed or housed in the central cavity. A front suspension module is connected to the front end of the central housing and a rear suspension module is connected to rear end of the central housing to complete a modular build for the rolling chassis assembly which improves on the large, heavy and cost intensive integral chassis associated with the prior skateboard architectures.

### CROSS-REFERENCE TO RELATED APPLICATION

This PCT International Patent application claims the benefit of U.S. Provisional Patent Application Ser. No. 63/281,957 filed on Nov. 22, 2021 titled “Modular Rolling Chassis Assembly For Skateboard Chassis Architectures,” the entire disclosure of which is hereby incorporated by reference.

### BACKGROUND OF THE INVENTION

### 1. Field of the Invention

The present invention relates to a chassis assembly for an electric vehicle. More particularly, the present invention relates to a chassis assembly for an electric vehicle based on a skateboard chassis architecture.

### 2. Related Art

This section provides background information related to the present disclosure which is not necessarily prior art.

Automobiles are the subject of a continuing effort to reduce weight and increase fuel efficiency without detracting from performance. This desire to increase fuel efficiency is both economically and environmentally motivated and has advanced internal components in automobiles as evidenced by developments in batteries, particularly in electrified automobiles. Electrified automobiles include a range of technologies that rely on electric energy to propel an automobile. Some electrified automobiles still rely predominantly on fossil fuels and use electricity as a supportive energy to improve fuel efficiency. Other electrified automobiles rely predominantly or entirely on electricity for propulsion of the automobile. Both electrified automobiles and traditional automobiles that operate entirely with fossil fuels utilize batteries to store electric energy and, while electric energy is a more economically and environmentally favorable technology than relying completely on fossil fuels, batteries are heavy, expensive, and relatively fragile compared to neighboring mechanical components. As such, the packaging of batteries, particularly within an electrified vehicle, requires a number of design considerations including weight distribution, temperature regulation, and serviceability. In terms of serviceability, there is a growing need particularly for electrified automobiles in which the batteries are located in an accessible configuration.

To meet the above minimum requirements, batteries traditionally have been packaged in protective housings that are constructed entirely independent from a frame of the automobile. As the automotive industry continues to trend towards primarily battery powered solutions, skateboard chassis architectures have become more popular. Skateboard chassis architectures typically include the battery housing, a suspension system, a brake system, and a propulsion system. Because many skateboard chassis assemblies include a majority of driving and electric components necessary to operate an automobile, they can be up-scaled for a variety of vehicle bodies. While the development of skateboard chassis architectures have improved certain aspects of vehicular architecture, there are still notable shortcomings. For example, there are a number of redundant structures between the skateboard chassis system and body-in-white. In addition, the battery housing provides weight and space without providing any structural functionality beyond carrying battery modules. Moreover, these traditional battery housings can be difficult to connect to a frame of the skateboard chassis, create weak points in the frame, and provide opportunities for galvanic corrosion between the battery housing and the body-in-white.

Furthermore, current skateboard chassis architectures are commonly arranged with the frame/chassis/body as a one piece, integral design type with the suspension parts directly mounted to this integral frame/chassis/body structure. In this instance, the electric energy storage system (ESS) is also added as an additional part to the frame/chassis/body, like historically has been done with fuel tanks. However, having an integral frame as a major part of the chassis leads to large, heavy and function separated parts. As a result, parts for the skateboard chassis architecture are determined specific to their location and implementation, resulting in an inflexible chassis structure. Put another way, the integral frame/body structure for the skateboard chassis architecture must be pre-designed with specific characteristics of chassis setting, like spring deflection, camber, toe, etc., leaving minimal design flexibility after manufacture.

Accordingly, there is a continuing desire to further develop and refine skateboard chassis architectures and operation such that they are not subjected to traditional drawbacks such as structural redundancies, inefficiencies, and lack of flexibility.

### SUMMARY OF THE INVENTION

A modular rolling chassis assembly for an electric vehicle includes a central housing extending from a front end to a rear end to define a central cavity, and an electric energy storage system (ESS) disposed in the central cavity. A front suspension module is connected to the front end of the central housing and a rear suspension module is connected to rear end of the central housing to complete a modular build for the rolling chassis assembly which improves on the large, heavy and cost intensive integral chassis associated with the prior skateboard architectures. Additionally, moving to smaller modules (i.e., the front suspension module, the rear suspension module and the central housing which houses the ESS) to modularly build the rolling chassis assembly provides for modules which can be used more often within the same vehicle and/or platform vehicles. The modular build of the rolling chassis assembly also drives reductions in tool, assembly and logistics cost. Put another way, the modular rolling chassis assembly advantageously separates and re-combines the function of the skateboard chassis into smaller module components and integrates them to the nearest function required to build the overall chassis for the skateboard architecture.

### BRIEF DESCRIPTION OF THE DRAWINGS

Other aspects of the present disclosure will be appreciated, as the same becomes more readily understood by reference to the following detailed description in combination with the accompanying drawings wherein:

FIG. 1 is a perspective view of a modular rolling chassis assembly illustrating a central housing and a front and a rear suspension module connected to a respective front or rear end of the central housing;

FIG. 2 is a perspective view of the modular rolling chassis assembly with a cover removed from the central housing to illustrate a central cavity housing an electric energy storage system (ESS);

FIG. 3 is a perspective view of the modular rolling chassis assembly with wheels removed from the front and rear suspension modules to more clearly illustrate the suspension components;

FIG. 4 is a perspective exploded view of the modular rolling chassis assembly with the front and the rear suspension modules removably detached from the central housing to illustrate a plurality of front and rear apertures defined by a top and bottom structural frame of the central housing for receiving fasteners to establish the connected relationship between the front and rear suspension modules and the central housing;

FIG. 5 is a bottom perspective exploded view of the modular rolling chassis assembly;

FIG. 6 is a magnified view of a portion of FIG. 5 illustrating a front flange of the front suspension module for mating with a front end of the central housing;

FIG. 7 is a perspective view of the central housing with a cover removed to illustrate the ESS housed within the central cavity; and

FIG. 8 is an exploded perspective view of the central housing.

### DESCRIPTION OF THE ENABLING EMBODIMENTS

Example embodiments will now be described more fully with reference to the accompanying drawings. In general, the subject embodiments are directed to a modular rolling chassis assembly 10 for an electric vehicle designed with a skateboard chassis architecture. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, a modular rolling chassis assembly 10 for an electric vehicle based on a skateboard chassis architecture is provided. The modular rolling chassis assembly 10 is designed to provide a skateboard chassis architecture that reduces redundant features, maximizes commodity consolidation, provides a battery housing that forms a part of the structural load path, and can be customized for a variety of end uses. The modular rolling chassis assembly 10 as described herein may be used in an electrified or semi-electrified automobile, such as a car, pick-up truck, SUV, semi-truck or the like.

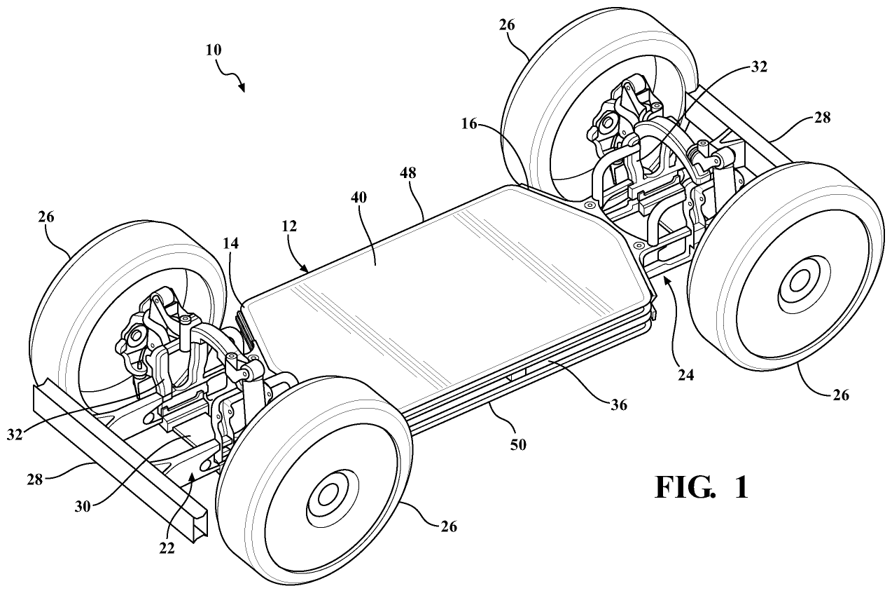

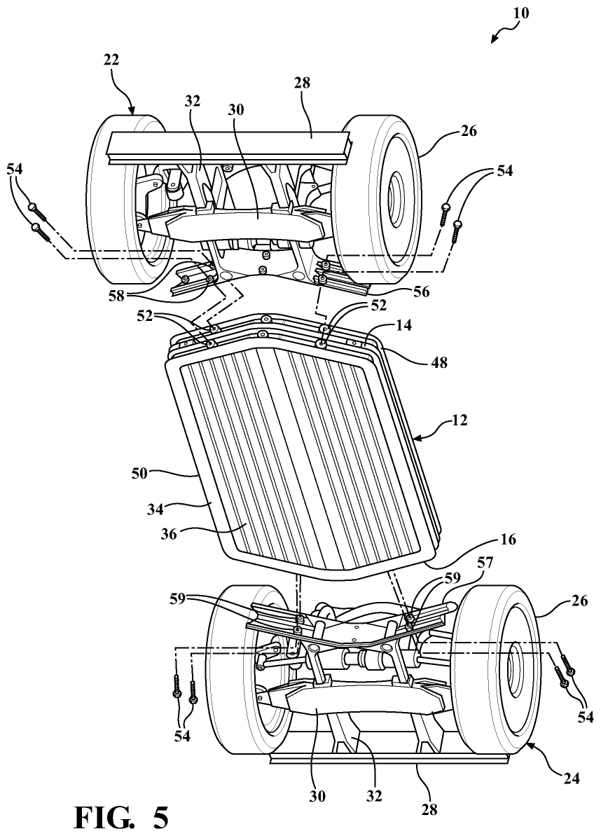

As best illustrated in FIGS. 1-5, the modular rolling chassis assembly 10 includes a central housing or module 12 being centrally located in the modular rolling chassis assembly 10 and extending from a front end 14 to a rear end 16 to define a central cavity 18. An electric energy storage system (ESS) 20 is housed or disposed within the central cavity 18. A front suspension module 22 and a rear suspension module 24 are each connected to respective ends 14, 16 of the central housing 12 to complete a modular assembly of the chassis and suspension for the resultant skateboard chassis architecture. The front and rear suspension modules 22, 24 can either be detachably connected or fixed (such as via welding or the like) to the central housing 12 without departing from the scope of the subject disclosure. In either arrangement, the modular build of the rolling chassis assembly 10 improves on the large, heavy and cost intensive integral chassis associated with the prior skateboard architectures, moving to smaller modules (i.e., the front suspension module 22, the rear suspension module 24 and the central housing 12 which houses the ESS 20), which can be used more often within the same vehicle and/or platform vehicles. This modular change/implementation drives reductions in tool, assembly and logistics cost. Put another way, the modular chassis assembly 10 advantageously separates and re-combines the function of the skateboard chassis into smaller module components 12, 22, 24 and integrates them to the nearest function required to build the overall chassis for the skateboard architecture.

In a preferred arrangement, the front and the rear suspension modules 22, 24 are designed as identical components to provide a nearly symmetrical design for the skateboard chassis architecture that reduces the number of different parts. Put another way, the front and rear suspension modules 22, 24 can interchangeably be connected to either of the front or rear ends 14, 16 of the central housing 12 to provide the possibility to reuse components of the front (part of the chassis) in the rear (carry-over strategy). Each of the front and rear suspension modules 22, 24 can include a pair of wheels 26 and a bumper 28 (to be arranged either as a front bumper or a rear bumper, depending on the respective connection to a front or rear end 14, 16 of the central housing 12 (i.e., an ESS carrier module)).

From a vehicle dynamics performance view, each of the front and rear suspension modules 22, 24 each still require different behavior characteristics depending on their ultimate arrangement as part of the front or rear suspension for the skateboard chassis architecture. Nevertheless, the front and rear suspension modules 22, 24 are preferably provided as identical components that are later modified with small setting parts, like adapters, scalable leaf springs, or slight machining to the major suspension parts, to achieve their desired implementation as a front or rear suspension module 22, 24. In principle, all parts of the front suspension module 22 can be re-used in the rear suspension module 24 implementation.

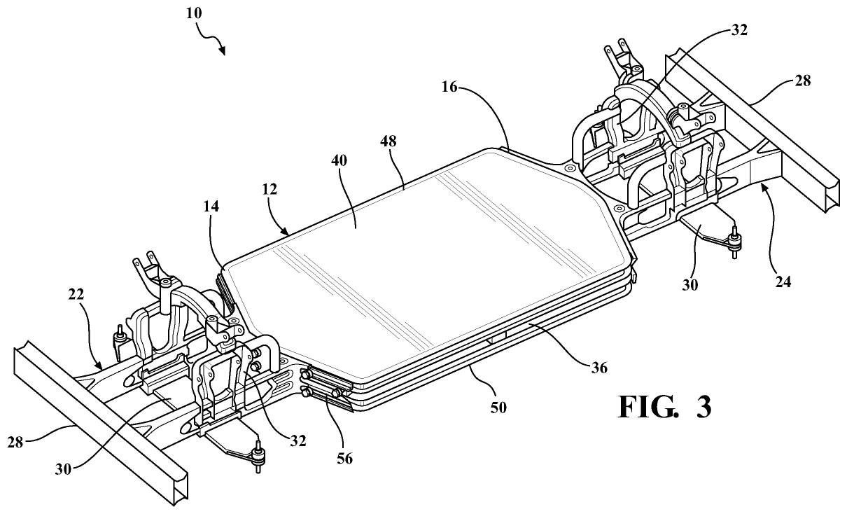

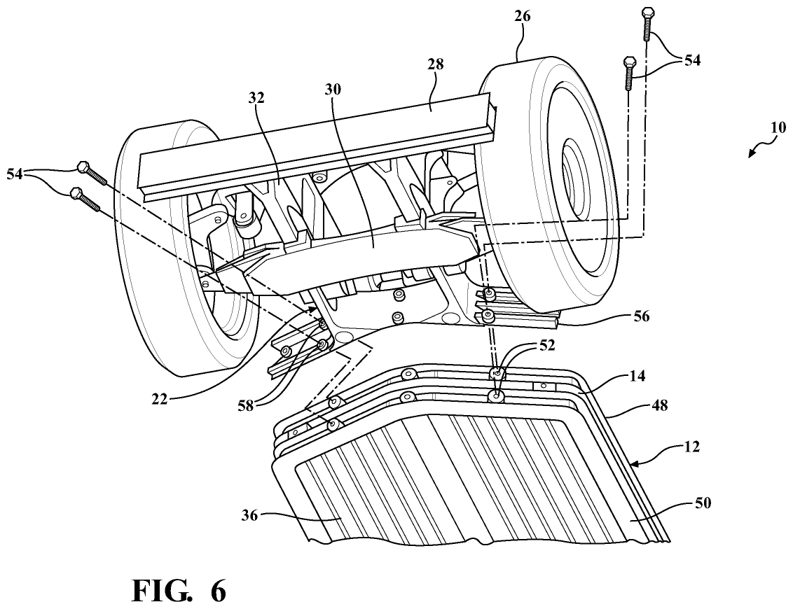

More specifically, each of the front and rear suspension modules 22, 24 are designed to specific vehicle dynamic aspect targets for the resultant skateboard chassis architecture, such as caster, camber, toe, bump/rebound, etc. These characteristics lead to defined positions of levers, links and springs in the front and rear suspension modules 22, 24. For example, as best illustrated in FIGS. 3 and 5-6, in an exemplary arrangement, the front and rear suspension modules can include a wheel trailing cross-car leaf spring 30 used in combination with an upper wishbone 32. A damper within the front and rear suspension modules 22, 24 connects the damped mass and un-damped mass using a ratio, with the stabilizer bar functionality handled by the leaf spring 26. Front and rear axles for the skateboard chassis architecture do have slightly different kinematic targets, e.g., rear axle should have mainly “toe-in” for all deflection positions. However, as mentioned previously, this condition can be satisfied by minor changes, such as machining semi-finished parts and/or with the help of adjustment (intermediate) parts. Driven and non-driven axles will also have different boundaries, which are considered and handled in the front and rear suspension modules 22, 24 with half shaft package, etc.

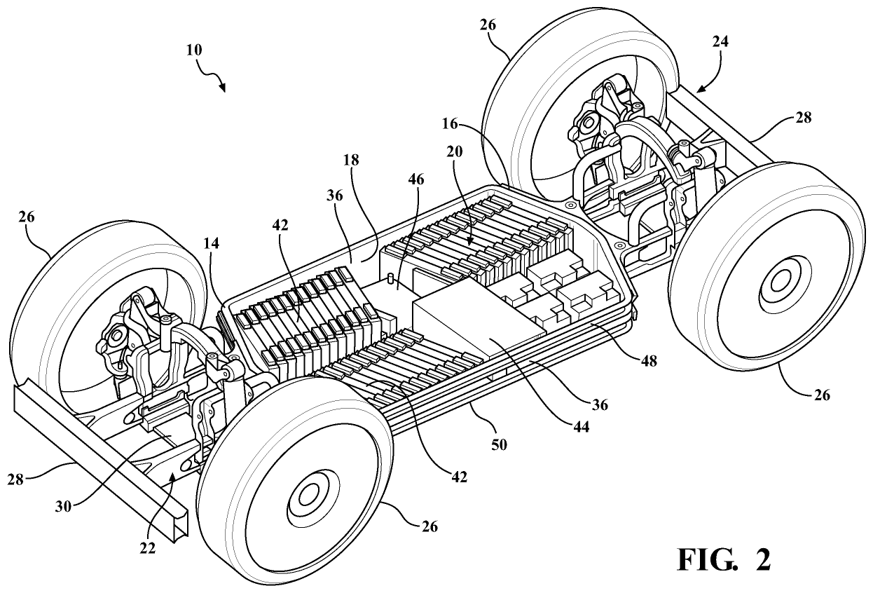

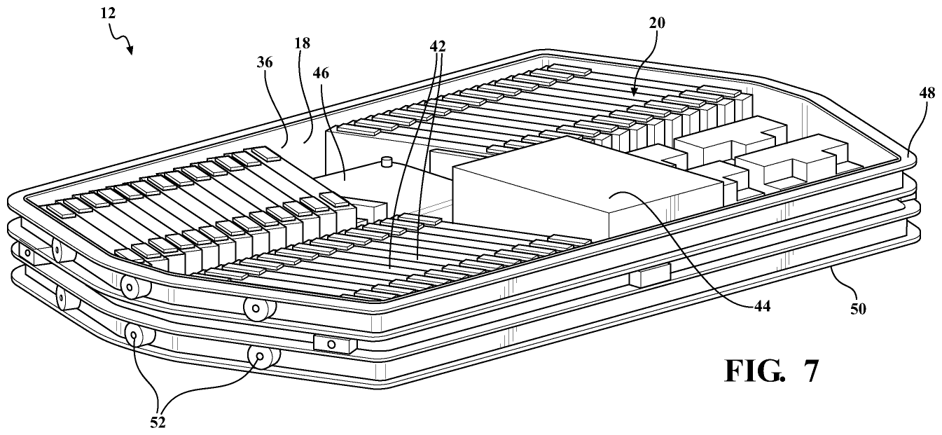

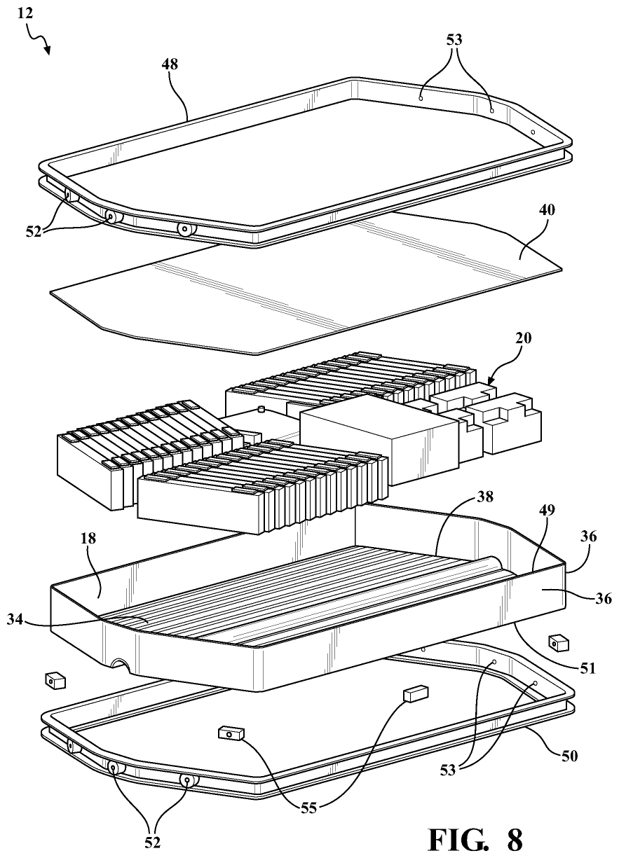

As best illustrated in FIG. 8, the ESS central module or housing 12 includes a floor 34 and a peripheral wall 36 extending upwardly from and continuously around an outer periphery 38 of the floor 34 to define the central cavity 18. The EES 20 is disposed inside of the central cavity 18 and a cover 40 is placed over and interconnected to the peripheral wall 36 to enclose and protect the ESS 20 within the cavity 18. In other words, the floor 34, the peripheral wall 36 and the cover 40 collectively define an enclosure which protects the ESS 20 from an environment of the modular rolling chassis assembly 10. As best illustrated in FIGS. 2 and 7-8, the ESS 20 includes a plurality of battery modules 42, as well as a battery management system 44, a power distribution unit 46, or any other electrical related parts.

With reference to FIGS. 1-5, the centered part of the modular rolling chassis assembly 10, in this case the central housing or module 12, provides boundary geometric conditions for the skateboard chassis architecture, bounded on the front and rear ends 14, 16 by the front and rear suspension modules 22, 24. Accordingly, the central housing or module 12 includes a top structural frame 48 extending along and adjacent a top portion of the peripheral wall 38, and a bottom structural frame 50 extending along and adjacent a bottom portion of the peripheral wall 44. The top and bottom structure frames 48, 50 provide structural integrity for the central housing or module 12, integrating stiffness, stress, and durability, while also doubling as a portion of the chassis/frame component for the skateboard chassis architecture. Accordingly, the central housing or module 12 extends upon previous functions for the battery housings in skateboard chassis (e.g., ESS carriers) by adding functions of a frame/chassis component to the central housing or module 12.

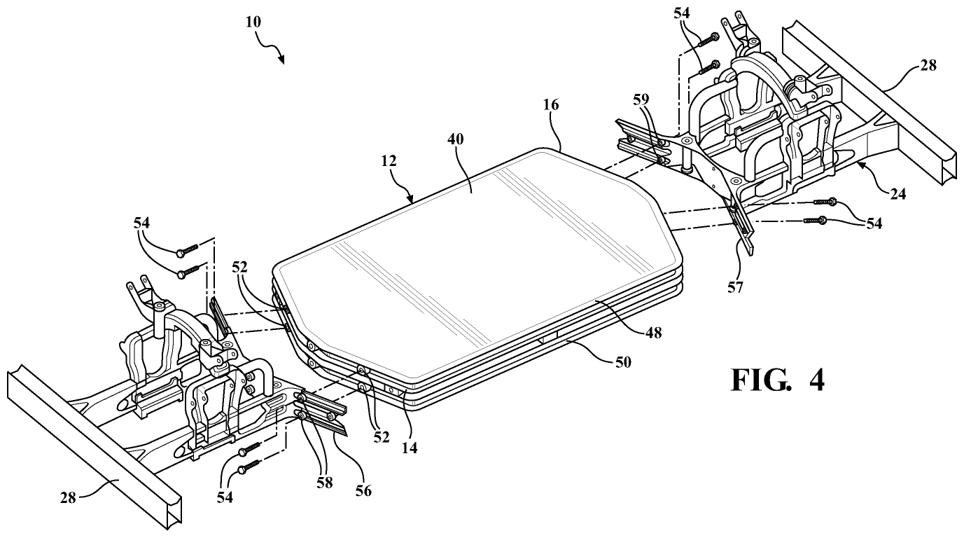

Each of the front and rear suspension modules 22, 24 are connected to both of the top and bottom structure frames 48, 50 to complete the modular assembly of the chassis/frame, and interconnect the front suspension module 22 to the rear suspension module 24. As mentioned previously, the front and rear suspension modules 22, 24 could be fixedly attached, e.g., via welding or the like, to the top and bottom structure frames 48, 50. However, in an alternative arrangement, the front and rear suspension modules 22, 24 are detachably or removably connected to the top and bottom structure frames 42, 44. For example, as best illustrated in FIGS. 4-8, the top and bottom structural frames each define a plurality of front apertures 52 disposed adjacent the front end 14 of the central housing 18 and a plurality of rear apertures 53 disposed adjacent the rear end 16 of the central housing 18. A plurality of fasteners 54 are each mated with a respective one of the plurality of front and rear apertures 52, 54 to establish the detachable connection of the front and rear suspension modules 22, 24 to the central housing or module 12. In this arrangement, a nut 55 or the like could be disposed within the central cavity 18 adjacent the aperture 52 for receiving the fastener and securing the nut 55 on an interior side of the peripheral wall 38.

As best illustrated in FIGS. 3-6, the front suspension module 22 can include a front flange 56 disposed in overlaying relationship with the front end 14 of the central housing 12 and the rear suspension module 24 can include a rear flange 57 disposed in overlaying relationship with said rear end 16 of said central housing 12. The front flange 56 defines a plurality of front through-holes 58 each disposed in aligned relationship with a respective one of the plurality of front apertures 52, and the rear flange 57 defines a plurality of rear through-holes 59 each disposed in aligned relationship with a respective one of the plurality of rear apertures 53. In this arrangement, each of the plurality of fasteners 54 extend through respectively aligned through holes 58, 59 and apertures 52, 53 and into said central cavity 18. The plurality of nuts 55 are disposed in the central cavity 18 and each secured to one of said plurality of fasteners 54 for establishing the detachable connection of the front and rear suspension modules 22, 24 to the central housing or module 12. Overlaying relationship of the front and rear flanges 56, 57 along the respective front or rear end 14, 16 of the central housing 12 also adds stability to and aligns the modules 12, 22, 24.

It should be appreciated that the foregoing description of the embodiments have been provided for purposes of illustration. In other words, the subject disclosure it is not intended to be exhaustive or to limit the disclosure. For example, although the central housing or module 12 is described to include an ESS 20, the modular rolling chassis assembly 10 could also be implemented in vehicle types which do not have an ESS, such as in passenger or freight compartments and which can be handled in via a similar arrangement of the chassis assembly (minus the ESS). Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A modular rolling chassis assembly for an electric vehicle comprising:
a central housing extending from a front end to a rear end to define a central cavity;
an electric energy storage system (ESS) disposed in said central cavity;
a front suspension module connected to said front end of said central housing; and
a rear suspension module connected to said rear end of said central housing.

2. The modular rolling chassis assembly as set forth in claim 1, wherein each of said front and rear suspension modules are detachably connected to said respective front and rear ends.

3. The modular rolling chassis assembly as set forth in claim 2, wherein said central housing having a floor, a peripheral wall extending upwardly from and continuously around an outer periphery of said floor to define said central cavity, and a cover placed over and interconnected to said peripheral wall to enclose said electric ESS within said central cavity.

4. The modular rolling chassis assembly as set forth in claim 3, wherein said central housing includes a top structural frame extending along and adjacent a top portion of said peripheral wall and a bottom structural frame extending along and adjacent a bottom portion of said peripheral wall to provide structural integrity for said central housing.

5. The modular rolling chassis assembly as set forth in claim 4, wherein each of said front and rear suspension modules connected to both of said top and bottom structural frames adjacent said respective front or rear ends of said central housing.

6. The modular rolling chassis assembly as set forth in claim 5, further comprising:
said top and bottom structural frames each defining a plurality of front apertures disposed adjacent said front end of said central housing and a plurality of rear apertures disposed adjacent said rear end of said central housing, and
a plurality of fasteners each mated with a respective one of said plurality of front and rear apertures and establishing said detachable connection of said front and rear suspension modules to said central housing.

7. The modular rolling chassis assembly as set forth in claim 6, wherein said front suspension module including a front flange disposed in overlaying relationship with said front end of said central housing and said rear suspension module including a rear flange disposed in overlaying relationship with said rear end of said central housing.

8. The modular rolling chassis assembly as set forth in claim 7, further comprising:
said front flange defining a plurality of front through-holes each disposed in aligned relationship with a respective one of said plurality of front apertures;
said rear flange defining a plurality of rear through-holes each disposed in aligned relationship with a respective one of said plurality of rear apertures;
each of said plurality of fasteners extending through respectively aligned through holes and apertures and into said central cavity; and
a plurality of nuts disposed in said central cavity and each secured to one of said plurality of fasteners for establishing said detachable connection of said front and rear suspension modules to said central housing.

9. The modular rolling chassis assembly as set forth in claim 1,
wherein each of said front and rear suspension modules includes a pair of wheels and a bumper.

10. The modular rolling chassis assembly as set forth in claim 3,
wherein each of said front and rear suspension modules includes a wheel trailing cross-vehicle leaf spring and an upper wishbone.

11. The modular rolling chassis assembly as set forth in claim 1,
wherein each of said front and rear suspension modules are welded to said respective front and rear ends of said central housing.

12. The modular rolling chassis assembly as set forth in claim 1, wherein said electric ESS includes a plurality of battery modules, a battery management system, and a power distribution unit.

13. The modular rolling chassis assembly as set forth in claim 1, wherein said front and rear suspension modules are identical structures to provide a symmetrical design for the modular rolling chassis assembly.

14. A modular rolling chassis assembly for an electric vehicle comprising:
a central housing extending from a front end to a rear end to define a central cavity;
an electric energy storage system (ESS) disposed in said central cavity; and
a suspension module connected to a respective front or rear end of said central housing.

15. The modular rolling chassis assembly as set forth in claim 14, wherein said suspension module is detachably connected to said respective front or rear end.

16. The modular rolling chassis assembly as set forth in claim 15, wherein said central housing includes a top structural frame extending along and adjacent a top portion of said peripheral wall and a bottom structural frame extending along and adjacent a bottom portion of said peripheral wall to provide structural integrity, and wherein said suspension module is connected to both of said top and bottom structural frames adjacent said respective front or rear end of said central housing.

17. The modular rolling chassis assembly as set forth in claim 16, wherein said top and bottom structural frames each define a plurality of apertures disposed adjacent said respective front or rear end of said housing, and a plurality of fasteners each mated with a respective one of said plurality of apertures and establishing said detachable connection of said suspension module to said central housing.

18. The modular rolling chassis assembly as set forth in claim 17, wherein said suspension module includes a flange disposed in overlaying relationship with said respective front or rear end of said central housing.

19. The modular rolling chassis assembly as set forth in claim 18, further comprising:
said flange defining a plurality of through-holes each disposed in aligned relationship with a respective one of said plurality of apertures;
said plurality of fasteners each extending through respectively aligned through holes and apertures and into said central cavity; and
a plurality of nuts disposed in said central cavity and each secured to one of said plurality of fasteners for establishing said detachable connection of said suspension module to said central housing.

20. The modular rolling chassis assembly as set forth in claim 14, wherein said suspension module includes a pair of wheels and a bumper.
